(19) United States
(12) Patent Application Publication
(10) Pub. No.: US 2008/0189609 A1
(43) Pub. Date: Aug. 7, 2008

(54) Method and system for creating customized output

(76) Inventors: Timothy Mark Larson, Prior Lake, MN (US); Kimberly Susan Noonan, Shakopee, MN (US); Eric Jon Loring, Prior Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/011,195

(22) Filed: Jan. 23, 2008

Related U.S. Application Data
(60) Provisional application No. 60/886,213, filed on Jan. 23, 2007.

(51) Int. Cl. G06F 17/00

(52) U.S. Cl. 715/273

(57) ABSTRACT

A system and method for design and creation of customized output is provided. The method includes establishing a template, developing a base output from the template, and customizing the base output to create a customized output. During each of these steps, the system and method provide flexibility such that the user is able to place and modify content on the template, base product, or output. Further, the system may be configured for collaborative creation of the customized output.

### FIELD OF THE INVENTION

This invention relates generally to a system and method for creation of customized output, and more specifically to a system and method for flexible design and creation of customized output such as printed output.

### BACKGROUND

Systems are currently available for creating customized output such as memory books (also known as photobooks). Many of these systems are provided online such that the are accessible via the internet. Thus, the system is provided on a server and content for use in the memory books may be stored on the system. In many available memory book systems, a user chooses page layouts for each page of the memory book. The page layout includes preset photo boxes and preset textboxes. A user thus chooses a page layout based on the number of photo images they would like to place and the orientation of those photo images. For example, if a user has four photo images, two vertically oriented and two horizontally oriented, the user searches for a page layout having two vertically oriented photo boxes and two horizontally oriented photo boxes. Typically the user then must accept the text boxes that are included in that layout. The user then drags and drops the photo images into the photo boxes and enters text into the text boxes. Currently available systems do not enable a user to customize output by placing and customizing photo boxes and text boxes.

Currently available systems generally are intended for individual use. Thus, a user may log onto a system and create a memory book on an account on the system. The user is provided with limited, if any, functionality for collaborating with others regarding the memory book. For example, the user may be permitted to share the memory book to another user but that other user cannot modify the memory book as saved on the initial user's system or provide any input to the user other than outside of the memory book system. Accordingly, a system permitting flexible customization of output, such as memory books, and/or collaborative customization of output, such as memory books, would be useful.

### BRIEF SUMMARY OF EXEMPLARY EMBODIMENTS

A system and method for planning and creating customized output is provided. The system and method provide for flexible design and creation of customized output such as printed output. In some embodiments, the system and method provides a single extensive resource for collaborative design and creation of output.

In one embodiment, a method for creating a customized output is provided. The method comprises creating a product template, uploading content, and customizing the product template. Customizing the product template includes placing photo boxes and/or text boxes on the product template and placing uploaded content within the placed photo boxes and/or text boxes.

In another embodiment, a computer implemented system for creating a customized output is provided. The computer implemented system includes a program component defining a design template, wherein the design template comprises layered templates. The computer implemented system further includes a program component for modifying content on the design template to create a product template, a program component for uploading content, and a program component for modifying the product template to create a customized output wherein modifying the product template comprises place text boxes and/or image boxes and/or embellishments on the product template, the layered templates guiding relative imaging of the text boxes and/or image boxes and/or embellishments, and wherein modifying the product template further comprises placing uploaded content into the text boxes and/or image boxes.

In a further embodiment, a system for creating a customized output is provided. The system comprises a create portion, a manage portion, and a customize and edit portion. The create portion output choices and template options and may be used for establishing a product template. The manage portion comprises an upload portion and a content library. The customize and edit portion comprises a design tool. The design tool facilitates adding image boxes and/or text boxes to the product template to create a customized output.

In a yet further embodiment, system for creating a customized output is provided. The system comprises a user interface for developing the customized output, a user component through which a user may contribute to the creation and design of the customized output, and a collaboration component through which multiple users interact in the creation and design of the customized output.

While multiple embodiments are disclosed, still other embodiments of the present teachings will become apparent to those skilled in the art from the following detailed description, which shows and described illustrative embodiments. As will be realized, the teachings are capable of modifications in various obvious aspects, all without departing from the spirit and scope of the present teachings. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 illustrates an exemplary layout of a memory book that may be designed using an embodiment of the method and system described herein.

FIG. 2 illustrates layered templates of a system for creating customized output in accordance with one embodiment.

FIG. 3 illustrates a flow diagram of a method for creating a customized output accordance with one embodiment.

FIG. 4 illustrates a block diagram of a system for creating a customized output in accordance with one embodiment.

FIG. 5 illustrates a flow diagram of creating a project in accordance with one embodiment.

FIG. 6 illustrates a block diagram of an upload portion of a system for creating customized output in accordance with one embodiment.

FIG. 7 illustrates a block diagram of an edit and customize portion of a system for creating customized output in accordance with one embodiment.

FIG. 8 illustrates a flow diagram of registration and sign on in accordance with one embodiment.

FIG. 9 illustrates a diagram of process flow through a system for creating customized output in accordance with one embodiment.

FIG. 10 illustrates a block diagram of a My Projects page of a system for creating customized output in accordance with one embodiment

FIG. 11 illustrates a flow diagram of inviting/sharing in accordance with one embodiment.

FIG. 12 illustrates a flow diagram of registration and sign on for an invitee in accordance with one embodiment.

FIG. 13 illustrates a flow diagram of leadership transfer in accordance with one embodiment.

FIG. 14 illustrates a flow diagram of a buy process in accordance with one embodiment.

FIG. 15 illustrates a flow diagram of a method for creating a customized output accordance with a collaborative embodiment.

FIG. 16 illustrates a method of creating a memory book in accordance with one embodiment.

FIG. 17 illustrates the method of FIG. 16 in further detail in accordance with one embodiment.

Throughout the figures, the same reference numerals and characters, unless otherwise stated, are used to denote like features, elements, components, or portions of the illustrated embodiments. Moreover, while the present invention will now be described in detail with reference to the figures, it is done so in connection with the illustrative embodiments.

### DEFINITIONS

The phrase “memory book,” as used herein, refers to a compilation of photos, text, captions, themes, colors, and/or others, created by a single person or a group of persons, for the purpose of commemorating, memorializing, or celebrating an individual, group, team, or event.

The term “project,” as used herein, refers to a collection of people and content used to create products

The term “product,” as used herein, refers to a customized output.

The phrase “design template,” as used herein, refers to a collection of storylines, backgrounds, frames, photo layouts, fonts, etc.

The phrase “product template,” as used herein, refers to a design template as modified during Edit and Customization.

The phrase “base product” or “base book,” as used herein, refers to a product template modified to include images and text.

The phrases “customized product” and “customized output,” as used herein, refers to a base product as customized by a user.

### DETAILED DESCRIPTION OF EXEMPLARY EMBODIMENTS

A system and method for flexible design and creation of customized output is provided. Generally, the system and method provide flexibility in customizing the output, enable collaborative creation of the output, and facilitate content integration from multiple sources. In exemplary embodiments, the system is provided online.

In an exemplary embodiment, the system and method comprise layered templates such that a user is provided with flexibility in laying out photo boxes and text boxes, moving photo boxes and text boxes, reshaping photo boxes and text boxes, and other customization options of the output. In some embodiments, the system and method are collaborative and provides a single extensive resource for groups or individuals to design, create, and, optionally, purchase output such as memory books. The system may further be used as a content repository and communication vehicle.

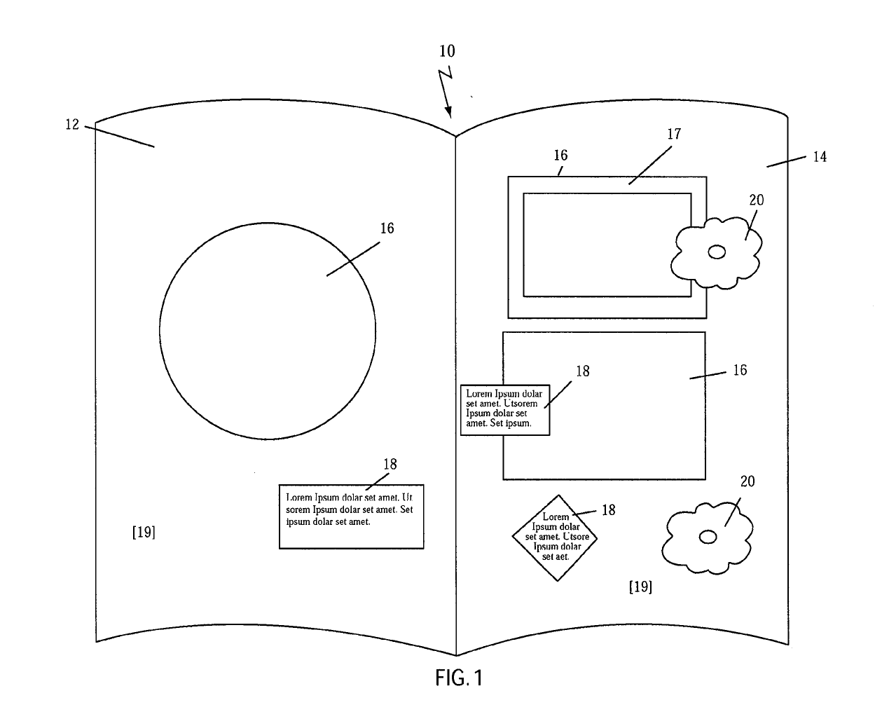

In some embodiments, the system and method are described with reference to creation of a customized memory book. FIG. 1 illustrates an exemplary spread 10 of a customized memory book in accordance with one embodiment. As shown, the spread 10 comprises first and second pages 12, 14. Photos boxes (or image boxes) 16, text boxes 18, and embellishments 20 are provided on the first and second pages. Mattes 17 are provided within the photo boxes 16. A background 19 may be provided on the first and second pages 12, 14. The background 19 may be the same on each page or may vary. Using the system and method described herein, size, shape, and position of the photos, text, and embellishments may be customized. It is to be appreciated that the system and method, in addition to creating memory books, may be configured for producing alternative printed output such as posters, collages, magnets, calendars or other printed output, or non-printed output such as DVDs or slideshows.

The system and method described herein permit flexible, and optionally collaborative, design, creation, and, in some embodiments, repurposing of output. An individual (user), a group of individuals (users), or an individual acting on behalf of a group may design an output. When more than one individual designs the output, such design is collaborative. A base product may be created during the design process and the base product used to facilitate creation of the finalized product output. The base product may be created manually, semi-manually, or automatically. In some embodiments, the product output may be created using a previous product output as a base product (thus repurposing a previous product) or using no base product.

Using the system and method disclosed herein, users have flexibility in designing, adapting, or modifying portions of the product output. For example, in embodiments for creating a memory book, users have flexibility in designing, adapting, or modifying each spread or page of the memory book. In collaborative embodiments, the system enables users to vote on content and to leave questions or comments for one another. The system and method enables manual, semi-manual, or automatic creation at various points in the method depending on the amount of customization desired by the user.

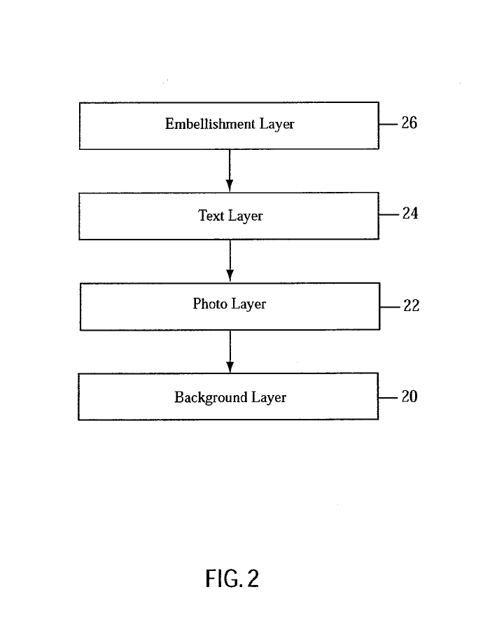

Flexibility in layout design may be provided, for example, by using layered templates. Thus, for example, a template may comprise a plurality of layers that are directed from a bottom layer to a top layer. These layers may comprise background, frame, matte, photo, text, embellishments, custom colors, or other suitable layers. The layers may be provided in this or other orders. Thus, each element of a template may have its own layer and the layers may determine how items are to be placed for visibility. Thus, for example, an upper layer overlays all layers below it and affects visibility of the layers below it. FIG. 2 illustrates one example of layered templates. While FIG. 2 illustrates example templates layered in one configuration, it is to be appreciated that other templates may be provided and/or fewer templates may be provided and/or the templates may be layered in a different order.

FIG. 2 illustrates an embodiment comprising four layers. The background layer 20 is the bottom layer, the photo layer 22 is the next layer, the text layer 24 is the next layer, and the embellishment layer 26 is the uppermost layer. In accordance with the embodiment of FIG. 2, all embellishments are visible because the embellishment layer 26 is the uppermost layer. If any embellishments overlay text, photos, or background, the portion of the text, photos, or background overlayed is not visible.

Similarly, if any text overlays photos or background, the portion of the photos or background overlayed is not visible. Lastly, if photos overlay background, the portion of the background overlayed is not visible. Thus, changes made to one layer on a page automatically are carried through to the visibility of the page without requiring modification of each portion of the page. For example, if a background is changed, images placed on a page do not need to be replaced. Similarly, if photo positioning boxes are removed from the photo layer 22, text remains in positions associated with the text layer 24.

In various embodiments, the system may be an online system and may be provided on a server such that the system is accessible via connection to the server. For example, users of the system can access the system via any user portal. As will be understood by one skilled in the art, the system and method may be available via an internet connection with associated personal computer user portal, a telephone connection with associated telephone user portal, a satellite connection with associated user uplink, or another other connection and associated user interface. Thus, the system may be provided through a telecommunications network wherein the user can access the system and/or other resources while on the system. Thus, using the system, the user can, for example, upload content available on the network, such as on the internet.

In some embodiments, more than one user may use the system and method to create an output. Users of the system may be designated in certain categories. For example, users may be leaders, user members, or other. The term “users” encompasses users of any category. The user type designation may grant or deny certain rights or accesses to the user. Thus, for example, a leader may have the ability to address errors or invite user members while a user member may not. The rights and accesses may be customized according to the specific use of the system. Further, in certain embodiments, all users may fall into the same category and have the same rights and accesses or a single user may use the memory book system. A single user or individual using the system acts as the leader of their own project.

### Single User or Limited Collaborative Creation

In a first embodiment, the system and method may be geared towards an individual user with optional limited involvement from other users for creation of an output. Thus, a single user designs and creates the output. It is to be appreciated that the output may be any output created using the system and involving placement of, for example, images, text, stickers, embellishments, or other. Thus, for example, in some embodiments, the output may be printed output such as a memory book while, in other embodiments, the output may be non-printed output.

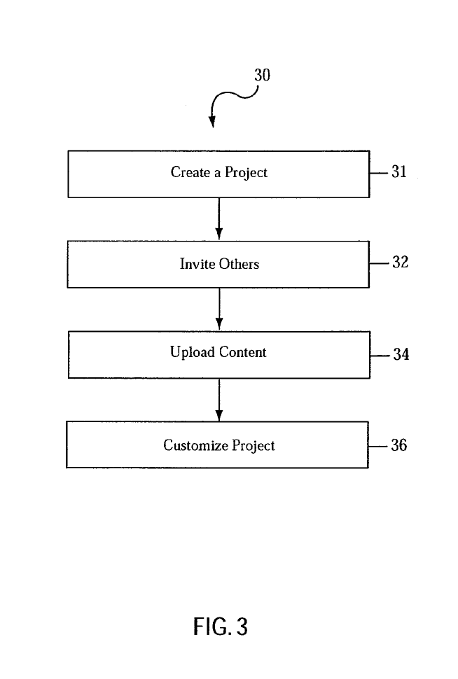

FIG. 3 illustrates a general method of creating customized output in accordance with a single user or limited collaboration embodiment. As shown, the method 30 includes creating a project [block 31], optionally inviting others to participate in designing the project [block 32], uploading content [block 34], and customizing the project [block 36]. As will be described, creating a project [block 31] may comprise selecting a project type and selecting a template for the project. In a limited collaborative creation, inviting others to participate [block 32] involves inviting others to upload content and/or vote on content. As will be described, customizing the project [block 36] may involve placing content on the project. Using the system and method described herein, content may be placed, edited, and customized as desired by the user. Thus, the user determines placement for the content.

It is to be appreciated that, once on the system, the user may proceed with output creation at any point in the creation process depending on the status of the output. For example, a user may proceed with designing or planning a project, uploading and categorizing materials to be used in the creation of the output, editing and personalizing existing output or base product, sharing output with others, and/or purchasing output (all described below). For the sake of clarity, discussion of the method proceeds with each step as would likely be carried out during creation of customized output. It is to be noted, however, that these steps may be performed in different orders, may not all be performed, may be supplemented with other steps, and are generally nonlimiting.

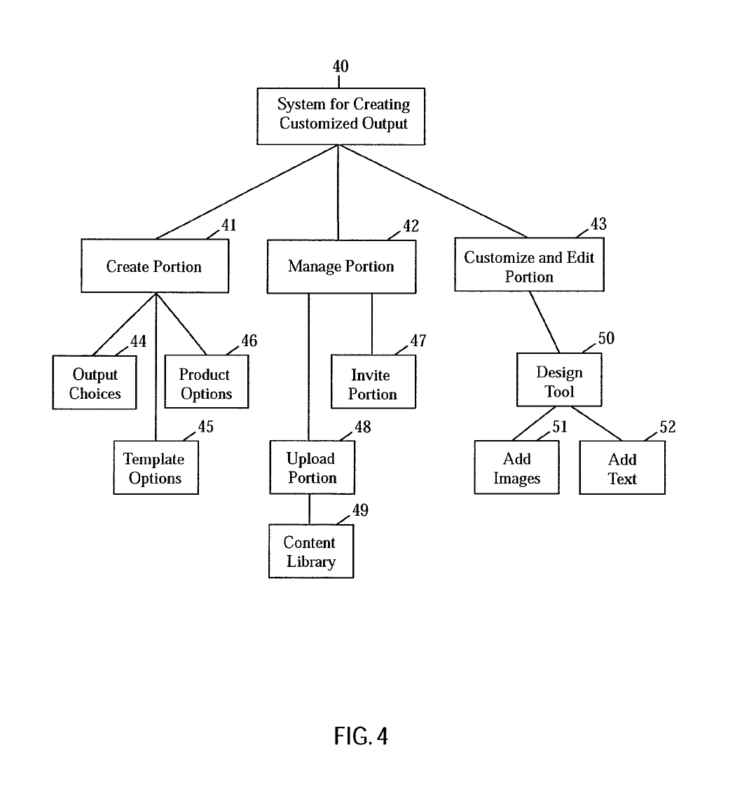

FIG. 4 illustrates a block diagram of components of the system 40. The system 40 includes a Create portion 41 a Manage portion 42 and a Customize and Edit portion 43. The Create portion 41 includes output choices 44, template options 45, and/or product options 46. The Manage portion 42 includes an Invite portion 47 and Upload portion 48. The Upload portion 48 includes a Content Library 49. The Customize and Edit portion 43 includes a Design tool 50 (including Add Images 51 and Add Text 52).

### Creating a Project

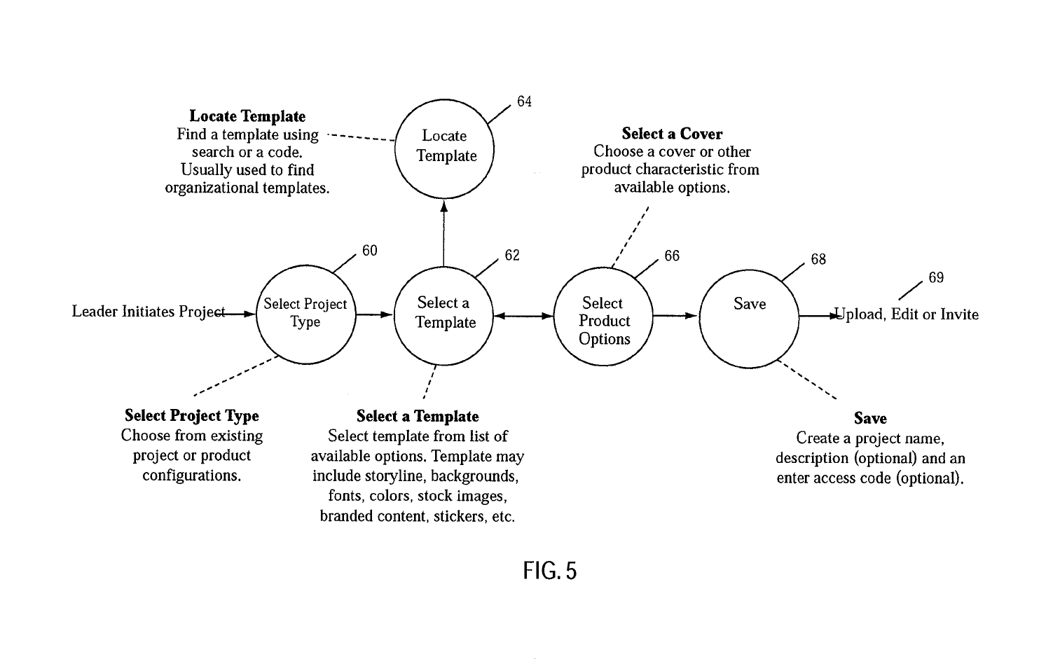

To begin a project, a user accesses the Create portion 41 of the system 40. FIG. 5 illustrates project flow through the Create portion 41. The user selects project type [block 60]. This may involve choosing from existing project or product configurations. Thus, for example, the user may choose whether to create a memory book, a calendar, a DVD, or other. The user then selects a design template [block 62]. The project template may be chosen from a list of available options. The project template may include one or more of storyline, backgrounds, fonts, colors, stock images, branded content, stickers, etc. For example, in an embodiment wherein a project template includes a storyline, other portions of the project template may be provided around the storyline. For example, in the example of a memory book, a storyline may be chosen associated with “baby”. The storyline could then include elements associated with “Expecting Baby,” “It's a Girl!,” “Going Home,” “The Nursery,” etc. The project template would put these elements in a preliminary order as one would expect them to appear in a book and would group stickers, embellishments, etc. associated with each of these together.

In one embodiment, colors, fonts, illustrations, covers, and other visual elements are pre-established based on each project template. The user thus may select a project template from a list of options; the project design template having associated visual elements.

In some embodiments, selecting a project template [block 62] may involve locating a project template [block 64]. Locating a template may be done by using a search or a code. Organizations or events may have project templates customized for provision on the system. Thus, for example, a school may have project templates utilizing the school colors and logo. Alternatively, an organization or event may have project templates including schedule, stock photos, etc. For example, a cruise line may have project templates for each cruise including the schedule of destinations, stock photos of the ship, and stock photos of each of the ports. These project templates may be locatable via a search or input of a code.

Content placed on a layer of the page thus may automatically take on the visual elements associated with that page. For example, visual elements associated with the design template may include font type, size, and color for text. Thus, any text added to the page may have that font type, size, and color. In some embodiments, to change the visual elements, the change must be universal to the page. In other embodiments, a user may change visual elements associated with a single portion, or generally less than all of the portions, of the page.

In an alternative embodiment, the user may further enter desired visual elements such as colors, fonts, illustrations, covers, and other visual elements. These desired visual elements may then be incorporated into the created project.

In some embodiments for creating memory books, selection of a design template may automatically start a project having a certain length. For example, the default length may be twenty pages, with the user having the option to add or delete pages (optionally within minimum and maximum lengths) during edit and customization. In an alternative embodiment for creating memory books, the user may enter desired book length, etc. and the book template then may be established with such book length.

In some embodiments of memory book creation, the user may select backgrounds for each page of the memory book. Generally, the project template created has a background associated with each page. Such selection may comprise selecting a single background for use on each page, a set of coordinated backgrounds for manual or automatic placement throughout the book, or a set of individually selected backgrounds for manual or automatic placement throughout the book. Selection of backgrounds may be included in the selection of visual elements. When pre-defined coordinated backgrounds are selected, the user may be given an option to modify the backgrounds, for example swapping out backgrounds. In some embodiments, a user may establish custom backgrounds, for example by uploading an image or a design. Such custom background may be established at any point during the creation process.

The user selects product options relevant to the output [block 66]. For example, with a memory book output, selecting options may comprise selecting a cover. Generally, the cover may be chosen from a list of available options. In some embodiments, the user may create the cover or may customize an existing cover. As will be appreciated, depending on the product being created, the user may be prompted to select other product options. For example, if creating a calendar, the user may be prompted to select the number of months appearing on each spread.

After, or during, project creation, the user may save the project [block 68]. Saving the project may involve creating a project name, adding a description, setting an access code, or other. The Create portion culminates in creation of a product template. In some embodiments, rather than going through each stem of the Create portion, a user may select a previously created or designed product to use as a product template. Thus, a user may repurpose an existing product to create the output. In some embodiments, the Create portion may culminate in creation of a base product, for example, where the product template is not changed to create a separate base product.

After the project has been created, the user may proceed to the Manage portion 42 of FIG. 4, including the Upload portion 48 and the Invite portion 47 or may proceed to the Customize and Edit portion 43 of FIG. 4 [block 69].

### Upload

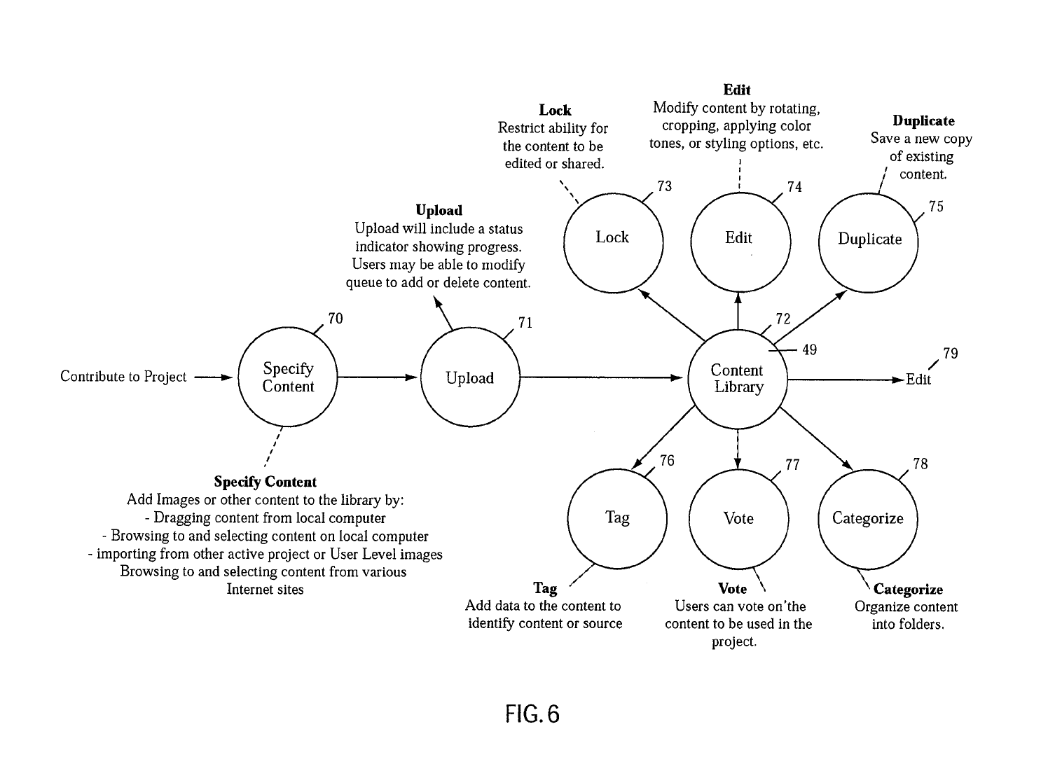

FIG. 6 illustrates project flow for uploading content to the Upload portion 48 of the Manage portion 42 system 40 (see FIG. 4). While particular reference is made to uploading images, it is to be appreciated that any suitable content may be uploaded to the system. For example, content may include images, stories, text, vignettes, information from other websites or content providers, or other. As previously discussed, the system 40 includes a Content Library 49 within the Manage portion 42. While reference is made herein to a general content library 49. In certain embodiments, the system may include a project content library comprising content for use in the specific project and a user level library comprising content for the user to use in any project. Copying and moving of the content may be bi-directional between the project content library and the user level library.

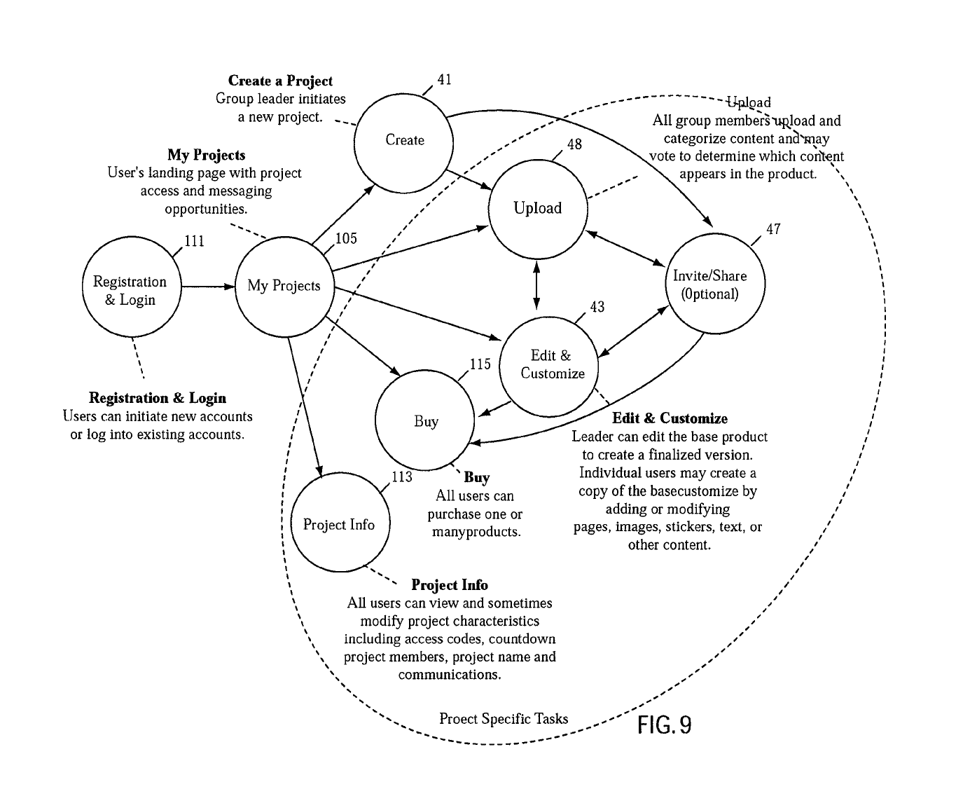

Now referring to FIG. 6, the user specifies the content to be uploaded [block 70] to add the content to the content library 49. Generally, FIG. 6 describes the content library 49 as a project content library. However, FIG. 6 may equally apply to a user level library. Specifying content to be uploaded may be done in any suitable manner. For example, images may be dragged from the local computer, images may be browsed to and selected from the local computer, images may be imported from another active project or from User Level Images of a user level library (discussed with respect to FIG. 9, below), images may be browsed to and selected from other internet sites, or other. In embodiments where the system is on a network, the system can directly access other sites for uploading content therefrom. After the content has been specified, the user initiates upload [block 71]. In some embodiments, uploading may include a status indicator showing progress of the upload process. In some embodiments, users may modify the queue to add or delete content. The content is uploaded to the content library 49 [block 72]. Several actions are available vis-à-vis the content library. These include, for example, lock 73, edit 74, duplicate 75, tag 76, vote 77, and categorize 78. Each of these is described below.

Lock 73 restricts user ability to edit or share the content. Lock 73 may be used where content may be moved or copied between a project content library and a user level library. For example, lock can be used to set whether people can copy the images and/or whether the content can be used for other projects. Edit 74 facilitates modifying content by, for example, rotating, cropping, applying color tones or styling options, and other known mechanisms for modifying content. Duplicate 75 saves a new copy of existing content. Duplicate may be done on an individualized basis (e.g., duplicating a single image) or on a batch basis (e.g., duplicating a folder of images). Tag 76 adds data to the content to identify a characteristic of the content—for example, to identify content (such as “Disneyland vacation photo”) or source of an image. Vote 77 facilitates users voting on the content to determine whether to use the content on the project. Categorize 78 creates a project name, description, and/or access code for a content item.

A user may modify the content after the content has been uploaded. For example, after a photo is uploaded, the photo may be modified or descriptors may be added to the photo. Thus, for example, users may perform corrections to photos, editing of the photo, or adding captions to the photo. Corrections may include, for example, cropping, rotating, red-eye reduction, and the like. Editing may include, for example, styling photos with color tones and vignettes. Captions may be, for example, identification of individuals in the photo, identification of the time or place the photo was taken, or adding any text to be associated with the photo. Similarly, if text such as stats has been uploaded, a user may add to, delete from, or modify the text.

In some embodiments, users may be prompted to vote on content. For example, if a user is unsure whether to include the content, the user may designate it for voting upon. In some embodiments, voting may be automatically initiated, for example, if more content than can be displayed in a given template has been uploaded for a project, the users may be prompted to vote on content. The results of this vote may be used to determine which photos are positioned in the base product or appear in the a preview of the output. Photos with the most votes may then be slotted for inclusion in the output.

The number of votes allotted to each user may be designated by the leader, based on the content, automatically, or other. For example, in one embodiment, each user may be allotted two votes for each category. In another embodiment, each user may vote on as much content as there are positions for in the template. Alternatively, a manual vote may be set up where users are prompted to vote on a selected number of pictures to decide on a selected number of pictures for inclusion.

If the leader of the project has initiated a project countdown, users may vote until the countdown expires. Alternatively, the user initiating the vote may set an end time for the vote. If no user has voted, the photos may be displayed in the order they were uploaded, date stamped, or otherwise designated. In alternative embodiments, content, or more specifically photos, for inclusion in the base product or output may be decided upon using any other suitable method. Further, the leader or another user may manually trigger a vote on content. For example, if a user has uploaded two photos and cannot choose which to place in the output, the user may initiate a vote between the two photos.

The user can proceed from the content library 49, or from the Upload portion generally, to the Customize & Edit portion [block 79].

### Edit and Customize

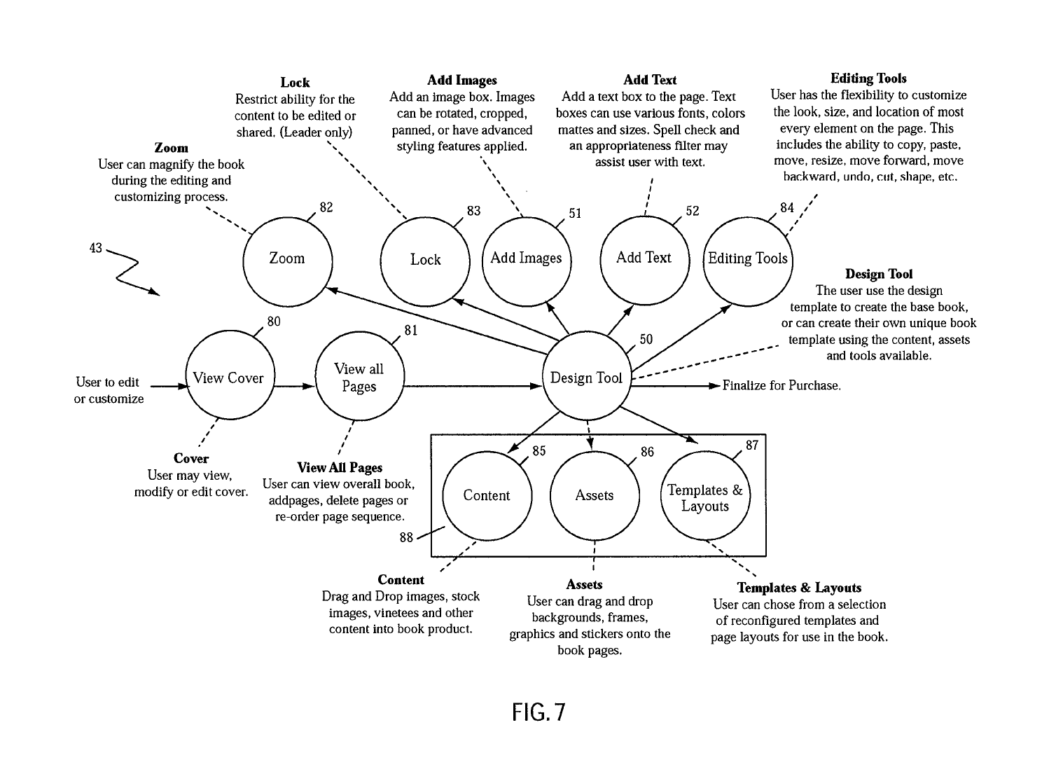

FIG. 7 illustrates an embodiment of the Edit & Customize portion 43 of the system 40 (see FIG. 4). FIG. 7 is specifically illustrative of an Edit & Customize portion 43 for a system and method for creating a customized memory book. As shown, the user can View Cover 80, View All Pages 81, or use the Design Tool 50. View Cover 80 facilitates viewing, modifying, or editing of the cover. As noted, the user may choose a template cover, customize a template cover, or create a new cover. View All Pages 81 facilitates user viewing the overall book, adding pages to the book, deleting pages, re-ordering page sequences, moving individual pages of the book, and other. The Design Tool 50 facilitates use of a design template to create a base book or to create a unique book template using content, assets, and tools available.

As shown, the Design Tool 50 provides access to the a Content Assets, Templates, and Layouts area 88 as well as tools for designing the memory book including Zoom 82, Lock 83, Add Images 51, Add Text 52, and Editing Tools 84. In various embodiments, more or fewer tools may be provided through the Design Tool 50.

In the embodiment shown, the Content Assets, Templates, and Layouts area 88 may be accessed from the Design Tool 50 to add content to the output. The Content Assets, Templates, and Layouts area 88 includes a Content Library 85, an Assets Library 86, and a Templates & Layouts Library 87. The Content Library 85 includes the content such as user images, stock images, vignettes, or other content. Optionally, the Content Library 85 may be the Content Library 49 of the Upload Portion (described with respect to FIG. 4), may be a mirror of the Content Library 49, or may be a different library from Content Library 49. The Assets Library 86 includes backgrounds, frames, graphics, stickers, and other embellishments. The Templates & Layouts Library 87 includes reconfigured templates and page layouts. Generally, content from the Content Library 85 and assets from the Assets Library 86 may be dragged and dropped onto pages within the memory book. Using the layered templates described with respect to FIG. 2, the system and method has flexibility to permit a user to place content and assets at any desired point on the page. A user can select templates and layouts from the Templates & Layouts Library 87 for use in the output.

Returning to the Content Library 85, vignettes may be stored in the Content Library 85. Vignettes may be incorporated into the system and method as a method of facilitating involvement by others without requiring their use of the system. For example, a user may send a notification to others requesting vignettes regarding a subject. In a specific example of creating a retirement book, a user may send a notification to others requesting stories about the retiree. These stories may be sent to the user and the user may upload or enter them and save them in the content library as vignettes. The vignettes may be formatted as text blocks or other. The vignettes may be configured such that they automatically take on the formatting of the page when placed on a page as text.

The Zoom tool 82 and the Lock tool 83 can affect user interface with the system but do not generally affect the end product of the process. Zoom 82 enables a user to magnify the output being created during the editing and customizing process. Lock 83 restricts ability of the content to be edited or shared. Other tools to facilitate user customization of an output may further be provided. For example, alignment tools may be provided such as an alignment grid or a tool to facilitate aligning objects with one another. Thus, a group leader (in a limited collaborative embodiment) may lock a page such that other group members cannot edit that page.

Add Images 51 facilitates a user adding an image box to a page. The user can select a shape for the image box, a border for the image box, or other. The user can size, rotate, or move the image box. After placement of the image box, the user can drag and drop an image from the Content Library into the image box. The image can be rotated, cropped, panned, have advanced styling features applied, or otherwise edited.

With reference to the layered templates of FIG. 2, in some embodiments a frame layer and a matte layer may be provided associated with the photo layer 22. The frame layer provides frames for photo positioning boxes; the frame layer thus generally establishes the photo positioning boxes. The matte layer provides mattes for image boxes. The photo layer 22 provides images for within the image boxes or photo boxes. Image boxes or photo boxes may be added or deleted. In some embodiments, the frame layer and the matte layer may be automatically applied to any newly created image boxes or photo boxes. These image boxes or photo boxes may be moved and the size of the image boxes or photo boxes may be adjustable. In some embodiments, the frame layer and the matte layer may be coordinated in a single graphic with areas of the graphic made visible through the defined coordinates of that layer. Thus the frame and matte layers can have a consistent or varied look depending on the graphic.

Returning to FIG. 7, Add Text 52 facilitates a user adding a text box to the page. The user can select a shape for the text box, a border for the text box, background or fill for the text box, or other. The user can specify font, color, matte, and size for the text. The user can size, rotate, or move the text box. After placement of the text box, the user can drag and drop content, such as a vignette, from the Content Library 85 into the text box. Spellcheck and an appropriateness filter may assist the user with text.

Embellishments or further decorative components may be added before or after content such as images and text has been positioned on the page. Embellishments may comprise graphics for addition to the page. Such graphics may appear as stickers, ribbons, buttons, or other decorative elements. Embellishments may be, for example, any digital image, such as clip art. Thus, for example, after a page has had content positioned thereon and the content has been modified as desired, a user may add embellishments to further customize the page. Referring to the example of a memory book for a sports team, an embellishment may comprise a sticker stating “Score!” or “Go Team!”. In some embodiments, a user may add embellishments by placing them anywhere on a page, including over existing content.

The Editing Tools 84 give the user flexibility to customize the look, size, and location of all or most of the elements on the page. This may include, for example, the ability to copy, paste, move, resize, move forward, move backward, undo, cut, shape, etc. any element on the page including images, text, stickers, graphics, and other. The system may further comprise tools to facilitate user creation of graphic elements, for example through drawing and cutting, or to create word stickers, or other embellishments.

Moving back from description of the creation of the project, description will be given of user access and use of the system.

### Registration and Sign On

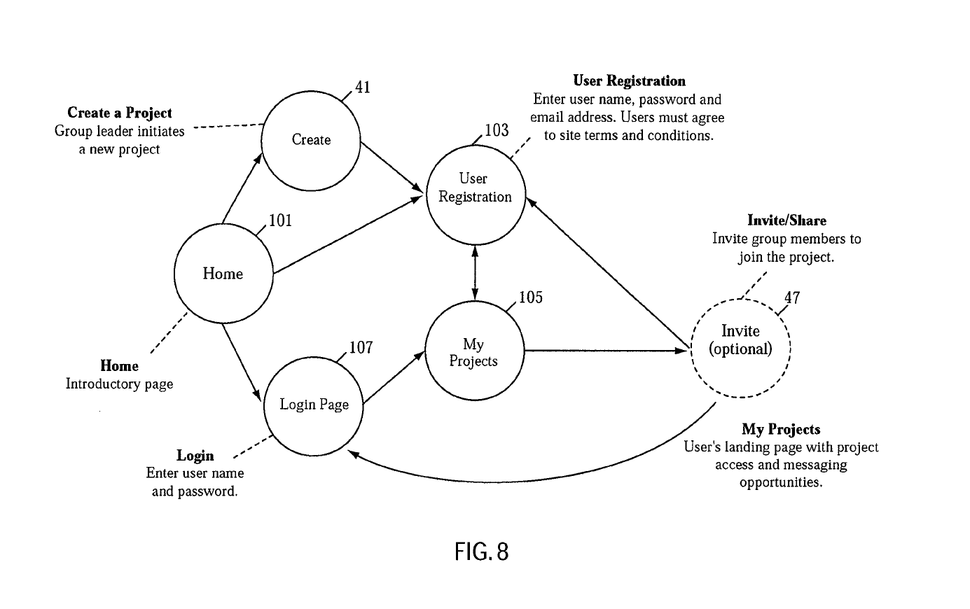

FIG. 8 illustrates a flow diagram of user registration and sign on or login. Generally, a user of the system registers with the system such that output created or designed using the system are associated with the user's account. Thus, in one embodiment, the user accesses a home page 101 of the system. If the user has not previous registered with the system, the user proceeds from the home page 101 to user registration 103. In various embodiments, user registration 103 may comprise inputting identifying information to create a user account or to access a user account. Such identifying information may be, for example, a user name, a password, an affiliation (e.g., of a team of a memory book is being created for a team), an email address, etc. Thus, in one embodiment, access is directed to login, for example via inputting identifying information to a login page. If a user is a new user, the user may be directed to register, for example, via a new user registration page. The new user registration page may require the user to, for example, enter identification information such as an email address and set up a password. It may also require the user to agree not to upload copyright protected material. If a user is an existing user, the user may log on directly by providing their login information, such as email address and password, for example.

In some embodiment, registration may be limited. In some embodiments, streamlined registration may be enabled such that users may be established on the system with limited information.

The user creates a project on the system using the Create portion 41 described above. After the project has been created, the user can access the project through a “My Projects” page 105 on the system. The My Projects page 105 is a user landing page with project access and messaging opportunities. It is to be appreciated that, in various embodiments, the user may perform various of these steps at different times. For example, an unregistered user may create a project and, upon determining that they want to complete the project and save the project on the system, can register. Further, after a user is registered, the user may access the system via a login page 107. After the project has been created, the user may access an Invite portion 47 of the Manage portion 42 to invite group members to join the project. Such joining may be limited (described below) or extensive (described with respect to Collaborative Creation).

### Process Flow Through My Projects Page

FIG. 9 illustrates a flow diagram of memory book creation in accordance with one embodiment. The process flow of FIG. 9 contemplates an individual user and in some instances, limited group involvement. In embodiments having group involvement, the individual user may be referred to as the group leader. As shown, the process may begin with registration and sign on or login 111. Users thus can initiate new accounts or log into existing accounts. As discussed above, a user may alternatively begin a memory book project and create an account or login thereafter. The user then accesses their My Projects page 105. The My Projects page 105 may display a variety of informational tools or control links. For example, the My Projects page 105 may display existing projects, including existing project details, as well as status information of existing projects and any notices with regard to existing projects. For all users of a project, the same information regarding that project may be provided on each user's My Projects page 105. Any other information that may be useful or informative to a user of the system may be provided in the My Projects page 105. For example, messages left by other users may be displayed in the My Projects page 105. Alternatively, in some embodiments, messages left by others may be displayed on a project preview.

With specific reference to the embodiment of FIG. 9, the My Projects page 105 can be used to access several different areas of the system including the Create portion 41, the Upload portion 48 of the Manage portion, the Edit & Customize portion 43, a Project Info portion 113, and a Buy portion 115. Each of these areas will be described in further detail below. In further embodiments, the My Projects page 105 can lead to more or fewer portions of the system. As can be seen from FIG. 8, various of these portion may be linked to one another such that they can be accessed from portions other than from the My Projects page 105. Thus, for example, a user could proceed from the Create portion 41 to the Upload portion 48. Further, it is to be appreciated that access paths other than those shown could alternatively be used. For example, a user could proceed from the Create portion 41 to the Edit & Customize portion 43.

As discussed with reference to FIG. 5, the Create portion 41 facilitates initiation of a new project. Generally, the individual user or the group leader initiates a new project. In an embodiment for memory book creation, new project initiation may involve choosing book size (for example, dimensions such as 8″×8″, 8.5″×11″, 12″×12″, or other), general format, cover, or other options related to the memory book.

An individual user can optionally invite other group members to participate in book creation. In the embodiment shown and described in FIGS. 3-14, group participation is limited. To invite others to participate, the group leader accesses the Invite/Share portion 47. The group leader can invite others to contribute content, collaborate, view, purchase, or customize and save their own version of the base product. The invitee can contribute content, collaborate, view, and vote on content. The invitee (and other group members) may further leverage the group's work by customizing the base product to create a customized output. Further, the user may customize the group's work to create a different output. For example, a user may take content from a group created memory book and incorporate it into a calendar. This may involve taking only the content items, such as pictures, or, if the outputs shared structures, taking entire portions of one output into another. Again, for example, in a memory book to calendar example, a page from a group created memory book may be copied in its entirety to a page in a calendar.

As discussed with reference to FIG. 6, the Upload portion 48 facilitates uploading and categorizing of content. If a group of users is included in creation of the output, the users can vote on the content to determine what content appears in the output. The individual user/group leader and the group members may upload content. Content may include photos, graphics, text, or other.

The Edit & Customize portion 43 facilitates customization of the memory book. Generally, the individual user or group leader can edit the base product (created in the Create portion 41). In some embodiments, other group members may have rights to edit the base product.

The Project Info portion 113 facilitates viewing and, in some embodiments, modifying project characteristics. The Project Info portion 113 may be accessible to all users including the group leader and the group members. Project characteristics may include, for example, access codes, project countdown, project members, project name, and communications. Access codes may comprise codes that connect a project to an outside resource such as a sales channel or organization. A project countdown can be used to define the project timeline in collaborative embodiments. Specifically, it can define the number of days until the project leader would like all content to be submitted and/or the timing until the base product is finalized. Project members generally comprise individual users invited by the project leader to participate in a project. Communications may comprise emails or reminders sent by the system on behalf of the project leader to inform about project timelines and status. In one embodiment, the system provides two options relating to messages as default. In further embodiments, the project leader can add additional customized messages. It is to be noted that, at various portions herein, email is used as an exemplary communication medium. However, any form of communication may be used between the system and a user and/or between users. For example, texting, instant messaging, calling, or other forms of communication may be used.

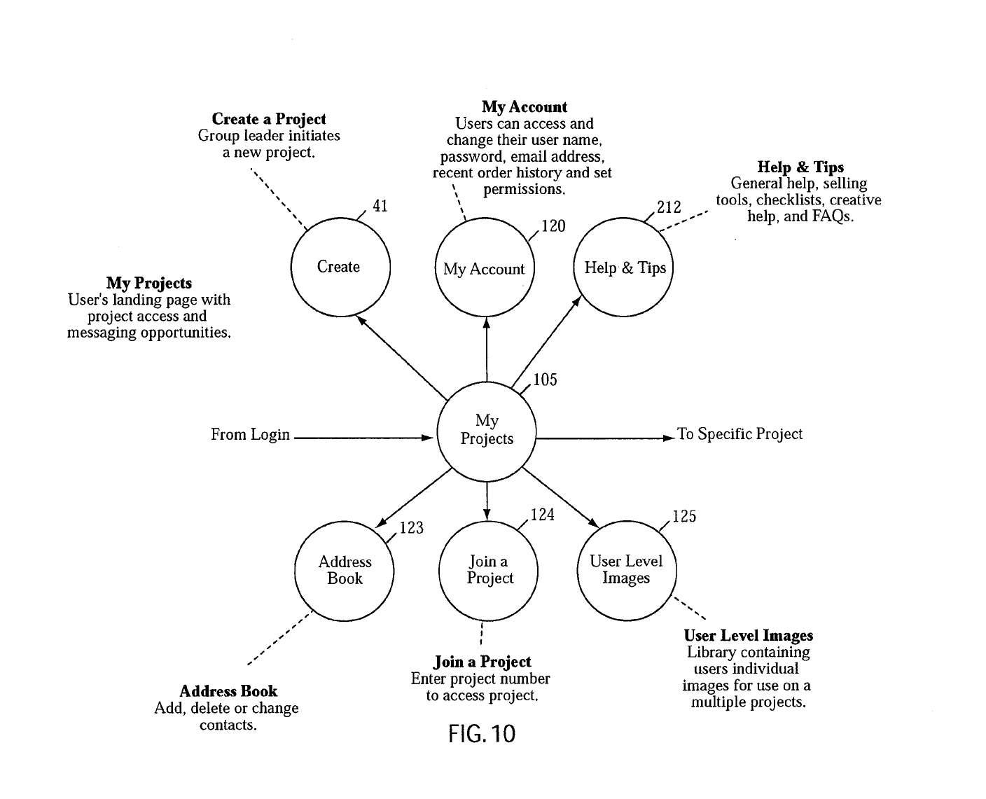

FIG. 10 illustrates a block diagram of a My Projects page 105 in accordance with one embodiment. As shown, the My Projects page 105 is accessed from Login or registration 111 (of FIG. 9) and may be used as a launching point to a specific project. Additionally, the My Projects page 105 provides access to various other portions of the system including, for example, the Create portion 41, a My Account portion 120, a Help & Tips portion 121, an Address Book portion 123, a Join a Project portion 124, and a User Level Images portion 125.

As shown, a user may access the Create portion 41 from the My Projects 105 to initiate a new project. The User may further access the User Level Images portion 125. The User Level Images portion 125 may comprise a library containing individual images of the user that may be used on one or more projects. The User Level Images portion 125 may be linked to the Content Library 49 of the Manage Portion 42 (See FIG. 4) The user may further access the Join a Project portion 124. At the Join a Project portion 124, a user may, for example, enter a project number to access a project led by a group leader.

A user may further access portions of the system not directly related to creating the memory book. For example, the user may access the My Account portion 120 to view and/or change their user name, password, email address, recent order history, and permissions. The user may access the Helps & Tips portion 121 to view general help, selling tools, checklists, creative help, and FAQs. The user may access the Address Book portion 123 to add, delete, or change contacts. Generally, the My Account portion 120, the Help & Tips portion 121, the Address Book portion 123, and similar portions provide context for the system and method but may not directly contribute to design of the final output.

### Invite/Share

A user can choose to use the system in a limited collaborative manner. This embodiment permits other users, group members, to add content, vote on content, etc. Generally, in the limited collaborative embodiments, group members other than the group leader may not have permissions to add content to the design of the output (in contrast to adding content to a library for accessing to design the output) and may not have permissions to edit content of the output. In alternative embodiments, group members may be given edit privileges, such as in the full collaborative embodiment described below.

While specific reference is made to inviting another user to participate in creation of the output, in some embodiments, a user may choose to share the output with other users without giving the other user any rights regarding creation. For example, users may share their designed output, portions of their designed output, images from their designed output, or other, with others. Users may select individuals to share a personalized book with by, for example, selecting members from a group list or entering an email address. Users selected to share the output are able to preview the output. Previewing the output allows users to examine the output by displaying a visual of the output.

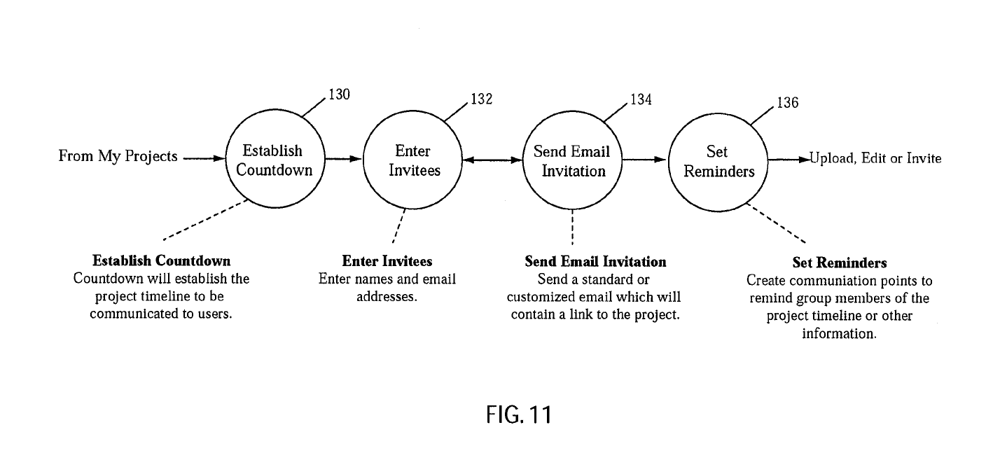

FIG. 11 illustrates process flow for inviting group members to the project. From the My Projects page 105 of the system, the group leader can establish a countdown [block 130], enter invitee information [block 132], send an invitation [block 134], and/or set reminders [block 136]. It is to be appreciated that more or fewer steps may be performed. Establishing a countdown [block 130] establishes a project timeline that is communicated to other group members. This may be useful when, for example, a memory book is being created for a team and they would like to share the memory book at the team banquet. In some embodiments, a countdown may not be established. Entering Invitee Information [block 132] involves the group leader entering names and contact information for invitees. Generally, the contact information may comprise email addresses. Sending an Invitation [block 134] may comprise sending a standard or customized email including a link, and optionally access code, to the project. Setting Reminders [block 136] may create communication points to remind group members of the project timeline or other information. In some embodiments, a user who has received a shared output may be able to edit and personalize the shared book. Generally, the shared output may be further customized or may be repurposed. All users that are selected to share the output may be given the option of purchasing the output. In some embodiments, only users invited by the leader may customize or repurpose the book.

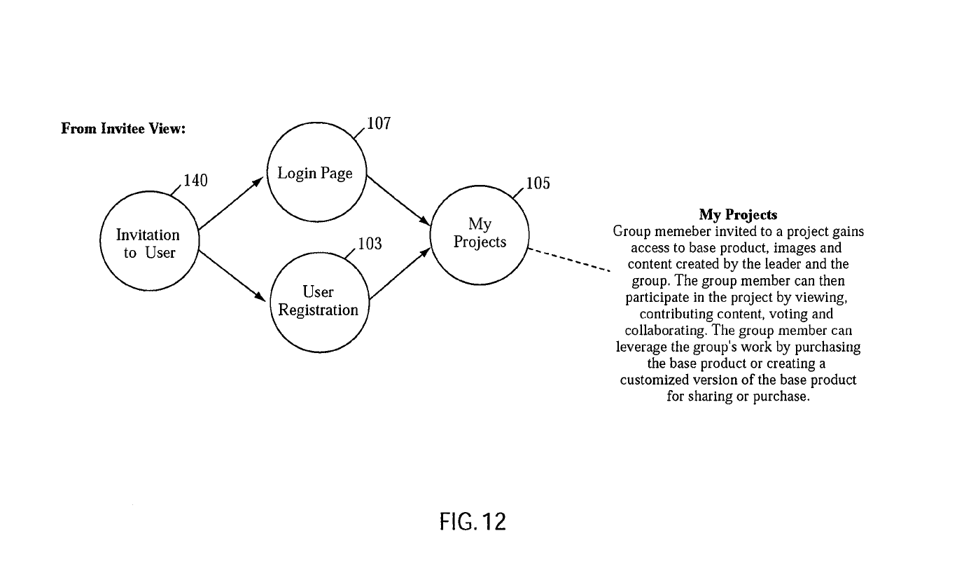

FIG. 12 illustrates a Registration and Sign On set up for an invitee. A group member invited to the project may, in some embodiments, access the base product, images, and content created by the group leader and other group members. Further, in some embodiments, the group member can participate in the project by viewing, contributing content, voting, and collaborating.

As shown, the user receives an Invitation 140. The user may link from the invitation to a login page 107 and/or user registration 103. Thus, if the user already has an account with the system, the user may login by entering user name and password. If the user does not have an account with the system, the user may register with the system by entering a user name, password, and email address. The user can then proceed to their My Projects page 105 where the user can access the base product, images, and content. This facilitates the invitee contributing to the group. The invitee further can save a version of the base product to customize output individually, thus leveraging the work completed previously on the project.

### Leadership Transfer

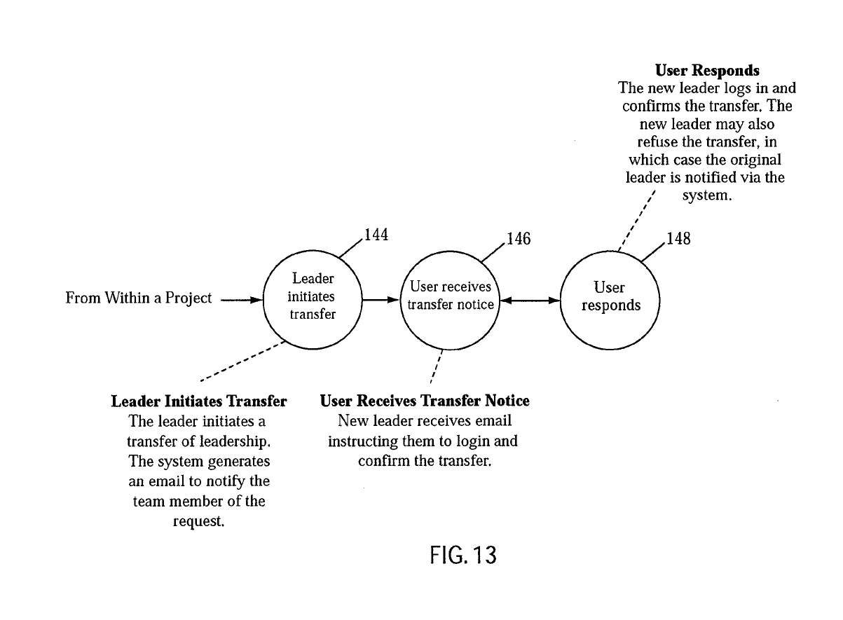

As shown in FIG. 13, a group leader may choose to transfer leadership. This transfers rights existing in the group leader to another group member. The transfer feature may initiate a cascade wherein a transfer notice is generated and sent to a designated user, the designated user receives the transfer notice instructing them to confirm the transfer, and the designated user responds by either confirming or denying the transfer. The designated user may confirm or deny the transfer by logging onto the memory book system.

With specific reference to FIG. 13, to transfer rights, the group leader initiates the transfer [block 144]. In one embodiment, initiation of a transfer of leadership automatically generates a notice to notify the team member to whom leadership is offered of the request. The user receives transfer notice [block 146]. The transfer notice may be sent, for example, via email, text messaging, phone messaging, or other. In one embodiment, the new leader receives an email instructing them to login and confirm the transfer. The user then responds [block 148]. In one embodiment, this involves the new leader logging in and confirming the transfer. The new leader may alternatively refuse the transfer, in which case the original leader is notified via the system and leadership rights remain in the original leader.

Upon transfer of leadership, navigational features on the My Projects page of the previous leader may be transferred to the My Projects page of the new leader and removed from the My Projects page of the previous leader. In some embodiments, leadership navigational features may be present on the My Projects page of both the new leader and the previous leader.

### Preview

Users may preview the output at any time during the creation process. For example, once content, including photos, text, data, or other, for a project has been uploaded into the system and placed in the project, the user may preview the output. Generally, the memory book preview feature provides the user with an opportunity to examine the progress of the memory book. In some embodiments, initiating project preview automatically populates the base product with uploaded content. In other embodiments, the project preview feature displays the content as positioned by the user or does not populate areas of the base product that have not been completed. The user thus may preview the memory book before all content has been uploaded to the system. Thus, partial previews may be performed. In some embodiments, the system may require that mandatory content (to be designated by the project leader during project design or planning) be input prior to project preview. In some embodiments, selecting the project preview feature may automatically trigger the system to save the memory book.

In some embodiments, the system may be configured such that a user is able to smoothly transition between previewing the output and editing the base product. For example, in a memory book embodiment, a preview of the memory book could display a page of the memory book. The user may want to change an element on that page. By clicking on that element, the user can be directed to that page without requiring intervening navigation. Similarly, the system may be configured such that while the user is editing a specific portion of the base product, for example, a page of a memory book, the user can click on that portion or designate that portion for preview and be directed to a preview of that portion without requiring intervening navigation.

### Buy

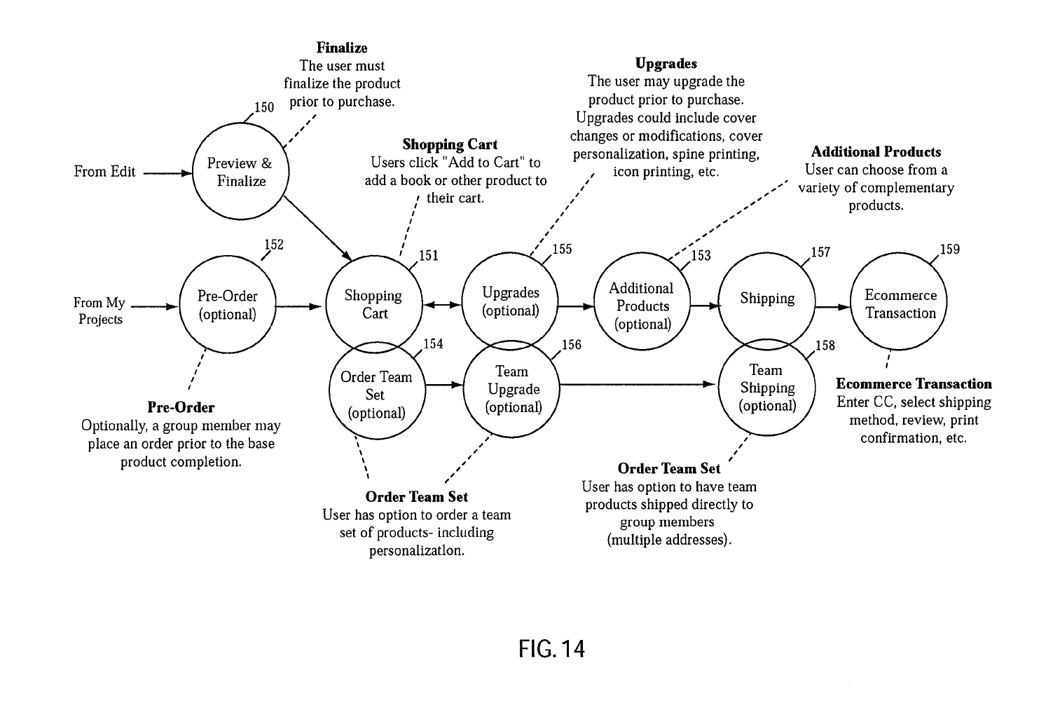

The system includes a Buy portion for purchasing the created output. One embodiment of a Buy portion is shown in FIG. 14. As shown, the Buy portion may be accessible from the Customize & Edit portion 43 (see FIG. 4) or from the My Projects page 105 (see FIG. 9). In alternative embodiments, the Buy portion may be accessible from other portions of the system.

Generally, when accessing the Buy portion from the Customize & Edit portion 43, the user must preview and finalize the product [block 150] prior to adding it to a shopping cart 151. In contrast, when accessing the Buy portion 115 of the My Projects page 105, the user may pre-order the product [block 152] prior to finalization of the output. While a specific method of placing an order and purchasing an output is herein disclosed, it should be appreciated that many methods are available and any of those methods may be used.

The buy portion 115 shown in FIG. 8 may be accessed by the user accessing a shopping cart feature by, for example, selecting an Add-to-Cart option. This option adds the output to the cart 151. Users may have previously placed output in the shopping cart by selecting the Add-to-Cart option at anytime throughout the creation and customization process. Further, users may have added output shared with them to the shopping cart. Within the shopping cart feature the user may also remove output previously placed in the shopping cart and update the quantities of each memory book to be purchased. Additional outputs 153 may be added to the shopping cart 151.

Optionally, the user can select an Order Team Set option 154 to order a team set of output. The Order Team Set option 154 may be used in lieu of the Add to Cart option or may be used within the cart after the output has been added to the cart via the Add to Cart option. Thus, in one embodiment, the user adds the output to the shopping cart 151 via the Add to Cart option and then selects within the cart that the output is ordered as a team set. In some embodiments, the Order Team Set option 154 may only be available to the group leader. The Order Team Set option 154 permits ordering a team set of outputs, optionally with each output personalized for the team member.

From the shopping cart 151, the user can optionally upgrade the output. Upgrades 155 may include, in a memory book embodiment, for example, cover changes or modifications, cover personalization, spine printing, icon printing, or other. When ordered as a Team Set, team upgrades 156, such as personalization, may be available.

After all outputs have been added to the shopping cart 151, the user may input or select shipping information [block 157]. When multiple outputs are in the shopping cart, the user may designate that all outputs are to be shipped to a single address or may designate an address for each output. Similarly, when Order Team Set 154 is selected, the user may have a Team Shipping option 158 where the user can have team books shipped directly to each group member.

To conclude the buy portion, the user may access an e-commerce transaction feature 159. The e-commerce transaction feature allows users to provide information regarding payment for the memory books and to indicate shipping preferences. Users may, for example, enter a credit card number, request a bill, select a method of shipment, review the contents of their purchase order, and print out a confirmation of their purchase order.

### Collaborative Creation

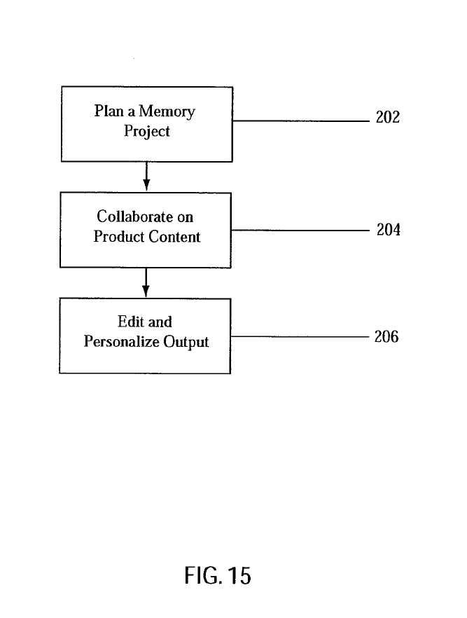

In an alternative embodiment, the system may be geared towards a group of users for collaborative creation of an output. FIGS. 15-17 illustrate a method of creating output in accordance with a collaborative embodiment. Very generally, as shown in FIG. 15, the method includes planning a project [block 202], collaborating on a project [block 204], and editing and personalizing the output [block 206]. As will be described, planning a project [block 202] may comprise setting up a template accessible by other members. Collaborating on a project [block 204] may comprise building a base product using a template (for example, in a memory book embodiment, a design template and subsequently book template, both described below) created during planning of the project [block 202]. Editing and personalizing [block 206] may comprise individually customizing the base product created during collaborating on a project [block 204].

It is to be appreciated that certain elements of the collaborative creation embodiment described with respect to FIGS. 15-17 may be used with the single user or limited collaboration embodiment described with respect to FIGS. 3-14. Further, certain elements of the single user or limited collaboration embodiment may be used in the collaborative creation embodiment. Thus, the embodiments shown and described are illustrative only and routine experimentation by one skilled in the art could lead to various combinations of elements disclosed herein and are within the scope of the present invention.

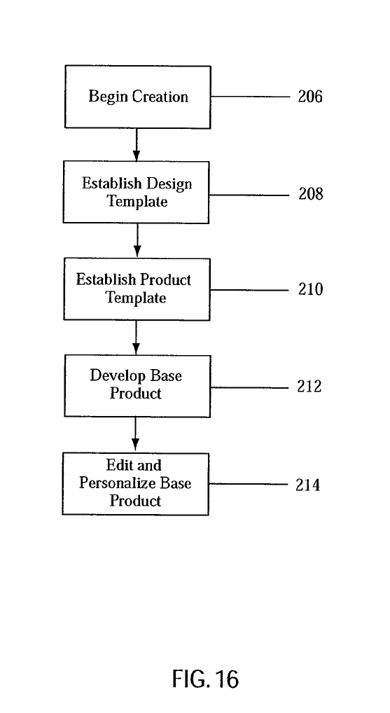

Reference is now made to FIG. 16 for an overview of creating customized output. While specific reference may be made to creating a memory book, this is for illustrative purposes only. As will be appreciated, the system and method disclosed could be used for creating any output such as printed output including calendars, mugs, magnets, and gift items, as well as other output such as DVDs or slide shows.

Returning now to FIG. 16, a user(s) begins creation or design of the output by initiating planning of the project [block 206]. In some embodiments, a single user member, who becomes the leader of the project, initiates planning of the project. In the embodiment shown, a first step in creating the output may be establishing a template. Establishing a template may comprise establishing a design template [block 208] and establishing a product template [block 210]. The design template is a combination of design such as backgrounds and graphics and may include photo placement and text placement. The design template may have a storyline as described above with respect to FIG. 5. Thus, for example, a sport storyline may comprise an Introduction, Team, Coaches, Game, or others.

Establishing a product template [block 210] may comprise converting the design template to a product template. The product template may then be used to collaboratively create a base product [block 212]. In some embodiments, the design template may be used directly as a product template and establishment of the design template [block 208] thus comprises establishment of the product template [block 210]. Generally, the product template becomes a base product when it is populated with content (e.g. images, text, vignettes, stickers, etc.) such that it is ready for editing by users other than the leader. In some embodiments, users other than the leader may be able to edit the product template.

The present disclosure refers to templates (design templates and product templates or book templates), base products or base books, and output or memory books. Generally, a template is the first iteration, the base product is the second iteration, and the output is the final iteration. In some embodiments, the template is designed by a project leader (for example, via selection of a design template and modification of the design template into a product template), the base product is developed by a team of user members, and the outputs are customized by individual user members. The outputs thus may be saved individually by each user member. These labels are not meant to be limiting and an output may be used as a base product for another project, the first iteration may be a base product (thus skipping the template steps), etc. Further, in alternative embodiments, as described with respect to the single user or limited collaborative embodiment of FIGS. 3-14, design of the template and base product may be combined into a single Create portion.

Returning to FIG. 16, in some embodiments, a design template may be established or created [block 208] by selecting from provided design templates, answering a questionnaire to generate the design template, selecting a previously created output (for example an output for the same group from a previous year or an output created for a group and customizable for an individual), or creating the design template from scratch (also referred to as manual creation). Using any of these (or other) methods, a design template is thus established [block 208]. The design template may be used to establish a product template [block 210]. More specifically, the design template may be modified to a product template by, for example in a memory book embodiment, adding pages, rearranging pages, adding placement positions for content, removing placement positions for content (e.g. removing photo positioning boxes), adding labels, adding categories, etc. In some embodiments the design template and the product template are the same (for example, in book creation or if the leader does not opt to modify the design template). Thus, in some situations, the terms design template and product template may be used interchangeably. The term “template” is intended to cover both design templates and product templates.

After the product template has been established [block 210], a base product is developed [block 212]. In the embodiments described with respect to FIGS. 15-17 developing the base product may be done using collaborative creation. Thus, while, in some embodiments, a single individual, e.g. the project leader, establishes the template (design and product), a team of user members may collaboratively create and develop the base product. In alternative embodiments, a team of user members may collaboratively modify the design template to create the product template. Creation of the base product comprises uploading content and customizing the base product using the uploaded content. The base product may then be finalized. In some embodiments, no base product may be designed and creation of the customized output may comprise uploading content as each portion (for example, page in a memory book embodiment) of the template is designed. Further, in some embodiments, output creation may begin directly with developing a base product.

After the base product has been developed [block 212], individual users may customize the base product into an outputby editing and personalizing the base product [block 214].

The system thus permits creation of customized output for a plurality users, based on a base product that may be created by the plurality of users. In some embodiments, the base product may comprise the final output and no further editing or personalization of the base product may be done. Creation of the base product or output by a plurality of users is considered collaborative creation. Collaborative creation is of use, for example, in creating output, such as memory books, for groups. A specific example, thus comprises memory book creation for a soccer team. Each player or parent of a player may comprise a user of the memory book system. Each player or parent of a player thus may contribute to the content uploaded to the system and ultimately used in the memory book. The player or parent of the player may then use the created memory book to create their own personalized version of the memory book.

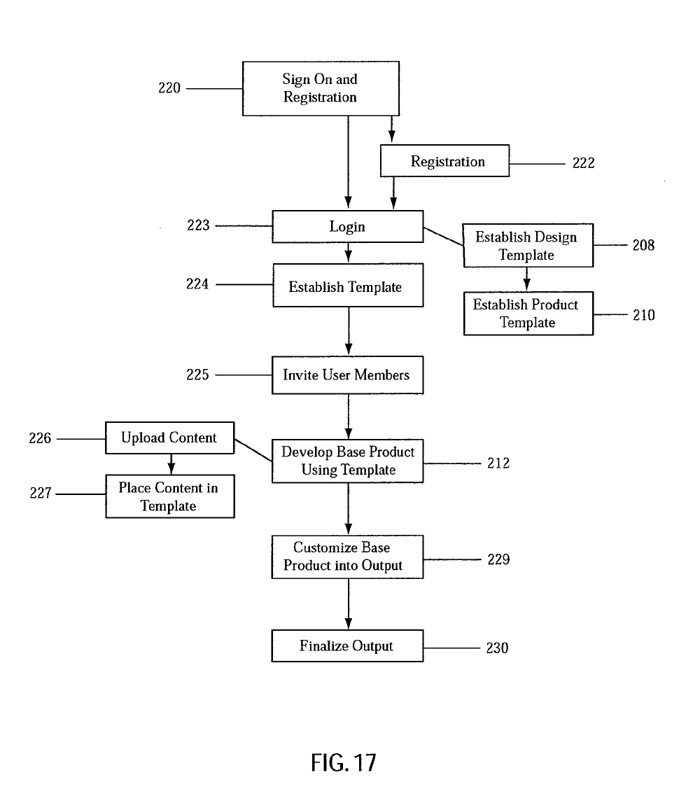

Referring now to FIG. 17, to begin memory book design and creation, a user signs onto the memory book system [block 220]. The user may log on directly [block 223] or may register [block 222] and then log on [block 223].

Once on the system, the user may proceed with output creation at any point in the creation process depending on the status of the output. For the sake of clarity and illustration only, discussion of the method proceeds with each step as would likely be carried out during creation of customized output.

Designing or planning a project generally comprises a portion of the method coinciding with initiation of a new project or memory book. In some embodiments, an access code or an affiliation may be linked to the project. In such embodiments, the user may be prompted to enter an access code or an affiliation. The code, whether an access code or affiliation code, provides the user with a link to other resources including, for example, additional templates, pictures, products, and information. An access code may provide access to content specific to a group. For example, a group leader of a project may save content uploaded during that project and associate it with an access code for others to access that content during other projects. An affiliation code may provide access to content specific to an affiliation. For example, a school may have content specific to that school and such content may be accessed through the affiliation code. While specific examples of an access code and an affiliation code are thus given, it is to be appreciated that these terms are not mutually exclusive and an access code may be an affiliation code.

### Establishing a Template

In one embodiment, designing or planning of the project comprises establishing a template [block 224]. Establishing a template [block 224] may comprise creating or selecting a design template [block 208] and establishing a product template [block 210]. Thus, in some embodiment, a user may select a design template from preset design templates and may modify that design template to create a book template.

Colors, fonts, illustrations, covers, and other visual elements may be pre-established based on each template. In an alternative embodiment, the user may further enter desired visual elements such as colors, fonts, illustrations, covers, and other visual elements. These desired visual elements may then be incorporated into the template suggestions and options, into the template, or other.

Some discussion will now be provided relating to memory book embodiments. In some embodiments, the user may select backgrounds for each page of the memory book. In one embodiment, the leader selects the backgrounds. Selection of backgrounds may be included in the selection of visual elements. When pre-defined coordinated backgrounds are selected, the leader may be given an option to modify the backgrounds or to allow other users to modify the backgrounds. In some embodiments, a user may establish custom backgrounds, for example by uploading an image or a design.

The user may enter desired book length, etc. and the book template then may be established with such book length. Alternatively, the book template may initially be created with a standard length that may be changed during customization of the base book into a memory book. For example, during developing the template, the book may be set at 20 pages. Whether the length of the book template is preset or set by the user, the length may be changed during customization of the base book.

At any point during design and creation of the memory book, materials for the book may be selected. These may include type of paper to be used in the book, type of cover, etc.

The template thus may comprise one or more pages. Each page may have a background associated there with. Each page may have a preliminary layout including positions for input of photos, text, or other. In some embodiments, each page may have styling associated with it. Thus, the page may be set such that text placed on that page has a certain font, size, and color or the page may be set such that any photos placed on that page are black and white. Styling and layout may be manually or automatically associated with each page during establishing the template [block 224 of FIG. 17].

A user may invite others or designate others for inclusion in creation of the customized output at any point during the design process. In the embodiment of FIG. 17, in the user invites or designates other users to participate in collaborative creation of the customized output [block 225] upon completion of the template. This timing is exemplary only and is not intended to be limiting. The user inviting or designating other users to participate may be the default leader of the project. In other embodiments, the user inviting or designating other users to participate may designate the leader.

Additionally, the user may set up a project countdown. As will be described, the countdown may be visibly displayed to users of the system and/or notices may be sent to users of the system.

### DEVELOPING A BASE PRODUCT

The template is used to develop a base product [block 212 of FIG. 17]. To develop a base book, the template may be collaboratively modified by users through the addition of photos, text, captions, colors, and other elements. In some embodiments, a template may not be created and collaborative creation may include designing the elements that could be included in the template.

Thus, after establishing the template, the method of creating a customized output in accordance with one embodiment comprises developing a base product. Developing a base product may include content collaboration. Content collaboration may include uploading content [block 226], placing such content in the template [block 227], and customizing the template to develop a base product.

Uploading content [block 226] may include uploading text, photos, any of the content discussed with respect to FIGS. 3-14, or other. Content may be uploaded by the user who created the design template (generally the project leader) or by any other user member. Generally, content is uploaded to an Image Library or Content Library. Folders or file repositories may be provided within the Library. Thus, a plurality of folders or file repositories may be created for receiving different content. For example, folders may be provided for “game pictures”, “candid pictures”, “team pictures”, etc.

The memory system may further be used as a content repository. Thus, the system may be used during a sports season for a team that will finalize the output after the season. Folders may be useful for organized use of the system as a content repository by enabling users to upload content directly to a folder for specified content after that content has been created. For example, shortly after Game 1, content related to Game 1 may be uploaded to the Game 1 folder.

Content may be uploaded from any suitable source including a local computer, a memory disc, another active project accessible by the user, the internet, or other. A user may modify the content after the content has been uploaded including making corrections, editing the content, or adding captions to the content. Content may be added to the folder, removed from the folder, reordered within the folder, designated for inclusion in the output, or designated for voting upon. In some embodiments, the system may be communicatively connected with other sources for receiving content from that source. For example, the system may be communicatively connected to a theme park for receiving content such as stock images or images taken during a visit to that theme park (where the user may have access codes to their pictures).

Content may be selected from the folder, for example the image library, for placement in photo positions in the memory book. Further, the template may be automatically populated with the photos based on the categories of the template and the associated file repositories or folders. Thus, photos from the Game 1 file repository may be automatically filled to the portion of the template categorizes as Game 1. This may be referred to as “auto-flow”. Alternatively, a user may manually place a photo in positions of the template.

As previously discussed, in some embodiments, system may be used as a content repository and a communication vehicle as well as a system for creating customized output. In such embodiments, content such as stats, scores, etc. may be uploaded to the system and converted for use in the project. Such conversion may be automated. In some embodiments, the system may be used for an extended period of time while content is being accumulated and thus use as a content repository may be particularly useful. Thus, for example in a memory book embodiment, memory book creation may begin almost concurrent with the start of a sports season (e.g., a soccer season). Content may be uploaded after each game or after various events. The content may be uploaded to a file repository specified for such content or may be uploaded to a general data repository and directed to a specific file repository at a later time. As a content repository, the content stays on the system throughout the season and can be used after the season. Alternatively, users may use the system throughout the season to collaboratively create a memory book during the season and finalize the book thereafter. Similarly, users may leave notes for one another throughout the season and thus use the system as a communication vehicle.

Uploaded, and optionally modified, content is placed in the template [block 227] to create the base product. Again, using a memory book embodiment as an example, each page of a base book may have a background and a preliminary layout including positions for input of photos, text, or other. The uploaded content thus may be placed in positions on the base book. Such placement may be manual or automatic. Thus, for example, manual placement may comprise selecting a specific position on a page and then selecting a specific photo to place in that position. Automatic placement may comprise, for example, selecting a page associated with “Homecoming Game” and a folder comprising photos from the homecoming game and the system may automatically populate positions on the page with photos from the folder. The user may thus place content in the memory book by automatically populating the base book with uploaded content in the appropriate categories.

Content may be designated for voting upon. The results of this vote determine which photos are positioned in the output.

During developing the base product [block 212], the user may modify the template to add more positions for receiving pictures or text, to change the sizing of positions for receiving pictures or text, to move the positions for receiving pictures or text, etc. In the example of a memory book embodiment, as previously described, each page may have styling associated with it. Thus, content placed on the page may automatically take on the styling associated with that page. In some embodiments, the user may modify the styling after placing content on the page. Such modification may comprise changing the styling associated with the entire page or changing the styling associated with a specific piece of content.

Embellishments or further decorative components may be added before or after content such as images and text has been positioned in the template. While addition of embellishments is discussed during development of the base output [block 212}, it could alternatively be done establishing the template [block 224], or during customizing the output [block 229]. In some embodiments, users may add embellishments by placing them anywhere on a portion of the template, including over existing content. Embellishments such as clip art may be chosen from libraries resident on the system.

During creation of the customized output, for example during development of the base product [block 212], users can communicate with one another. In various embodiments, users may embed comments or flags on the base product for viewing by other users. For example, in one embodiments, users may place an error tag identifying an error. Further, users may use graphical notes to make comments to one another. The graphical note may appear, for example, as a paper note with a comment thereon. The note may be restricted to removal by the user placing the note or may be removable, by only selected users, or by any user. As previously discussed, the system may also be used as a communication vehicle. Graphical notes facilitate such use. At any time during the creation process, the user may preview the base product as the output. In some embodiments, previewing may be done after content, including photos, text, data, embellishments, or other, for a project has been uploaded and placed [blocks 226, 227], the user may preview the base output base book would appear. The user thus has the opportunity to examine the progress of the project. If the users are satisfied with the base product, the base product may be finalized [block 230]. Alternatively, the users may proceed with further creation of the base product.

### Final Output

Once the countdown has expired or the base product finalized, the base product may be used to create the customized output. In some embodiments, the leader may indicate that the base product creation process has been finished at any time. At this point, a user may choose to modify a finalized base product, modify a previously saved base product, modify a shared output created by another member, purchase the base product as is, or purchase a shared output created by another member. The finalized base product may be personalized by users to create final output.

Thus, the finalized base product may be the final product purchasable by users or other individuals, may be customized to create a final output, or may be used as a new base product for customization by users or individuals seeking to purchase a customized output. Returning to the example of a sports team memory book, a finished memory book for the sports team may be used as a base book for a memory book for an individual player of the team. That player may add further pages with her photos or memories, replace photos, add photos, remove photos, change text, etc.

Accordingly, in some embodiments, after creation of a finalized base product, a user establishes the finalized base product as their base product and proceeds with edit-and-customization of the base product. A finalized base product thus may be customized into a finalized output. Such customizing comprises editing and personalizing the base product, including of addition, deletion, or changing of content of the base product.

Referring to customization of text, a user may edit the text by, for example, adding or deleting text as well as changing font size, style, or color. Referring to customization of photos, a user may edit photos by, for example, deleting, adding, or swapping out photos. Users may also crop photos or adjust the position of the photos within the template. Referring to embellishments, a user may edit embellishments by adding, deleting, or replacing embellishments. Referring to stats, schedules, and other content, a user may edit the content to include pages that include shared group information or a subset of such information.

In a memory book embodiment, during customization of a finalized base book to create the final memory book, a user may add pages or modify the cover. When adding pages, a user may add pages at any position in the finished base book, designate the number of photos to appear on each additional page, etc. In modifying the cover, the user may customize the cover by, for example, adding or deleting text, photos, or stamps. Further, the user may change the materials of the book, such as the paper, the material for the cover, or the content of the cover.

The user may preview the customized output at any point during customization of the finalized base product. The user may proceed directly from previewing the output to finalizing the output [block 230] and/or purchasing the output or may return to customizing the base product to create the output [block 229].

The user may share the customized output with other users at any point during edit-and-customization (also referred to as edit-and-personalization) of the base product. Users may select individuals to share a customized output with by, for example, selecting members from a group list or entering an email address. Users with whom the output is shared may be given the option of further editing and personalizing the output (as a user member of the group) or may be given the option of previewing and/or purchasing the output.

Repurposing of an output created using the system and method may comprise using a finished output as a base product during design of a base product or may comprise using a finished output as a base product during customization of a base product. Returning to the example of a sports team memory book, a finished memory book from one year can be repurposed and used as a base book for the next year. Repurposing may include manual, semi-manual, and automatic elements. For example, pictures may be automatically removed with the position staying in place on each page such that pictures from the new year may be inserted. Alternatively, pictures may be individually removed. Similarly, text may be automatically removed, individually removed, or individually modified.

Although the present invention has been described with reference to specific embodiments, persons skilled in the art will recognize that changes may be made in form and detail without departing from the spirit and scope of the invention.

What is claimed is:

1. A method for creating a customized output, the method comprising:
creating a product template
uploading content; and
customizing the product template, wherein customizing the product template includes placing photo boxes and/or text boxes on the product template and placing uploaded content within the placed photo boxes and/or text boxes.

2. The method of claim 1, wherein creating a product template comprises creating a design template and modifying the design template to create the product template.

3. The method of claim 2, wherein formatting is associated with the design template.

4. The method of claim 2, wherein modifying the design template and/or customizing the product template comprises changing at least some of the formatting associated with the design template.

5. The method of claim 1, wherein uploading content is done collaboratively.

6. The method of claim 1, wherein uploading content comprises uploading at least one of photos, text, vignettes, or clip-art.

7. The method of claim 1, wherein customizing the product template further comprises adding embellishments to the page.

8. A computer implemented system for creating a customized output comprising:
a program component defining a design template, wherein the design template comprises layered templates;
a program component for modifying content on the design template to create a product template;
a program component for uploading content;
a program component for modifying the product template to create the customized output, wherein modifying the product comprises place text boxes and/or image boxes and/or embellishments on the product template, the layered templates guiding relative imaging of the text boxes and/or image boxes and/or embellishments, and wherein modifying the product template further comprises placing uploaded content into the text boxes and/or image boxes.

9. The computer implemented system of claim 8, wherein the design template is the product template.

10. The computer implemented system of claim 8, further comprising a program component for enabling collaborative creation of the product template.

11. The computer implemented system of claim 8, wherein the layered templates comprise an embellishment layer, a text layer, a photo layer, and/or a background layer.

12. The computer implemented system of claim 8, wherein uploading content comprises uploading at least one of photos, text, vignettes, or clip-art.

13. The computer implemented system of claim 8, further comprising a library component for storing uploaded content.

14. The computer implemented system of claim 13, wherein the library component comprises a user-level library component and a project level library component.

15. A system for creating a customized output comprising:
a create portion for creating a product template wherein the create portion comprises output choices and template options;
a manage portion comprising an upload portion and a content library; and
a customize and edit portion comprising a design tool wherein the design tool facilitates adding image boxes and/or text boxes to the design template to create a customized output.

16. The system of claim 15, wherein the create further comprises product options based on the output choices.

17. The system of claim 15, wherein the manage portion further comprises an invite portion.

18. The system of claim 15, wherein the content library comprises a user level library and a project level library.

19. A system for creating a customized output comprising:
a user interface for developing the customized output
a user component through which a user may contribute to the creation and design of the customized output; and
a collaboration component through which multiple users interact in the creation and design of the customized output.

20. The system of claim 19, wherein the user component facilitates adding text boxes and/or adding image boxes to a template for designing the customized output.
